(19) United States
(12) Patent Application Publication
(10) Pub. No.: US 2018/0091589 A1
(43) Pub. Date: Mar. 29, 2018

(54) WEIGHTED FLOW DISTRIBUTION, AND SYSTEMATIC REDISTRIBUTION UPON FAILURE, ACROSS POOL OF PROCESSING RESOURCES TAKING ACCOUNT OF RELATIVE LOADING

(71) Applicant: Radisys Corporation, Hillsboro, OR (US)

(72) Inventors: James Radley, Church Crookham (GB); Andrew Alleman, Portland, OR (US)

(21) Appl. No.: 15/717,790

(22) Filed: Sep. 27, 2017

Related U.S. Application Data
(60) Provisional application No. 62/400,560, filed on Sep. 27, 2016.

(51) Int. Cl. H04L 29/08; H04L 12/803

(52) U.S. Cl. CPC H04L 67/1029; H04L 67/1034; H04L 47/125; H04L 67/1017

(57) ABSTRACT

To facilitate high throughput, disclosed are lightweight processes, suitable for implementation on a network processor unit, for assigning new workloads to a pool of processing resources, in which the processes include considering each processing resource's relative loading. The disclosed techniques facilitate coping with assigning new work to individual processing resources in a ratio relating to their most recently advertised spare capacity. Also, the disclosed techniques include assigning workloads to buckets, which in turn are allocated to processing resources as a means of load distribution. Thus, the allocations are amenable to rapid redistribution within a subset of active services so as to recover from the failure of a processing resource. Support for elastic provisioning is facilitated by blocking any new load going to a processing resource that has been marked for eventual graceful shutdown.

### RELATED APPLICATION

This application claims the benefit of U.S. Provisional Patent Application No. 62/400,560, filed Sep. 27, 2016, which is hereby incorporated by reference herein in its entirety.

### TECHNICAL FIELD

This disclosure relates generally to load balancing and, more particularly, to weighted load balancing.

### BACKGROUND INFORMATION

In packet switching networks, traffic flow, (data or network) packet flow, network flow, datapath flow, or work flow (or simply, flow) is a sequence of packets, typically of an internet protocol (IP), conveyed from a source computer to a destination, which may be another host, a multicast group, or a broadcast domain. Request for Comments (RFC) 2722 defines traffic flow as “an artificial logical equivalent to a call or connection.” RFC 3697 defines traffic flow as “a sequence of packets sent from a particular source to a particular unicast, anycast, or multicast destination that the source desires to label as a flow. A flow could consist of all packets in a specific transport connection or a media stream. However, a flow is not necessarily 1:1 mapped to a transport connection [i.e., under a Transmission Control Protocol (TCP)].” Flow is also defined in RFC 3917 as “a set of IP packets passing an observation point in the network during a certain time interval.” In other words, a work flow is a stream of packets associated with a particular application running on a specific client device.

In previous attempts, work flows were load balanced across servers in a rudimentary statistical fashion. One attempt at load balancing is the subject of U.S. Pat. No. 8,553,537 titled, “SESSION-LESS LOAD BALANCING OF CLIENT TRAFFIC ACROSS SERVERS IN A SERVER GROUP” of Tienwei Chao et al., assigned to International Business Machines Corporation of Armonk, N.Y. This patent includes a citation to a 2007 paper titled, “Load Balancing Between Server Blades Within ATCA Platforms,” authored by the present co-inventor, James Radley, who is an employee of Radisys Corporation of Hillsboro, Oreg.

Radisys has developed a FlowEngine™ product line characterized by a network element, e.g., a firewall, load balancer, gateway, or other element types, having a high throughput, optimized implementation of a packet datapath (also called a forwarding path). Additional details of the FlowEngine concept are described in a Radisys Corporation white paper titled “Intelligent Traffic Distribution Systems,” dated May 2015.

### SUMMARY OF THE DISCLOSURE

When new-work-flow logic is called upon to nominate a server to handle a previously unknown flow, it is advantageous for a system to assign the flow to the least loaded server that is available to process the new flow. But in low latency systems or high throughput environments, there is insufficient time for a load balancer to individually interrogate, in response to every new unit of work, the various processing resources (PRs) so as to obtain an instantaneous snapshot of their spare processing capacity. It is also burdensome on the PRs to excessively report this spare processing capacity information. Nevertheless, it is beneficial for a load-balancing function to take account of current loading on each PR and to favor allocating new units of work to those resources recently reporting having spare processing capacity. Thus, this disclosure describes capacity-aware allocation techniques for establishing a weighted round-robin list derived from a recent snapshot of PR utilization. Distribution in weighted round-robin fashion facilitates each PR being assigned in turn a new unit of work for proportionally distributing the units of work to multiple PRs based on spare processing capacity reported by each PR.

This disclosure describes use of an asynchronous thread or other means to obtain recurring snapshots of PR-processing capacity that are then used to create a weighting table—or other suitable data structure—for tracking the spare capacity, utilization, or other metric indicating a PR's ability to accommodate new flows. New flows are assigned to buckets that have been (re)allocated to each PR. Over time, such schemes evenly distribute work and thereby balance PR loading.

In some embodiments, the disclosed techniques are also used to favor assigning a new unit of work to any new PR recently introduced into the system because it initially has spare capacity. Another use case is when a peak need for a service has passed and the number of PRs providing the service can be reduced. In this case, so-called elastic scaling can be achieved by marking in the weighting table some PRs as being surplus and ensuring that no further flows are assigned to them. Eventually, existing flows assigned to the marked PR will all cease due to natural lifecycle termination. When it has no active flows or work assigned, the marked PR then may be withdrawn from service.

This disclosure also describes embodiments implementing weighted distribution techniques using a low latency, high throughput packet handling device such as a network processor unit (NPU) or other specialized logic circuitry having minimal state storage and rapid execution for high throughput.

Additional aspects and advantages will be apparent from the following detailed description of embodiments, which proceeds with reference to the accompanying drawings.

### BRIEF DESCRIPTION OF THE DRAWINGS

FIG. 1 is an annotated block diagram of a bucket-based load balancing paradigm.

FIG. 2 is an annotated block diagram showing an example of weighted load balancing by distribution of subscribers into four groups of buckets corresponding to four PRs labeled PR0-PR3.

FIG. 3 is a pair of annotated tables showing in the top and bottom tables, respectively, a first example of a bucket distribution among five PRs (PR0-PR4) and a second example of a redistribution, in response to PR2 failing, among PR0, PR1, PR3, and PR4.

FIG. 4 is a block diagram of hierarchical processing tiers of a load balancer, according to embodiment, for controlling the bucket-based load balancing paradigm shown in FIGS. 1-3.

### DETAILED DESCRIPTION OF EMBODIMENTS

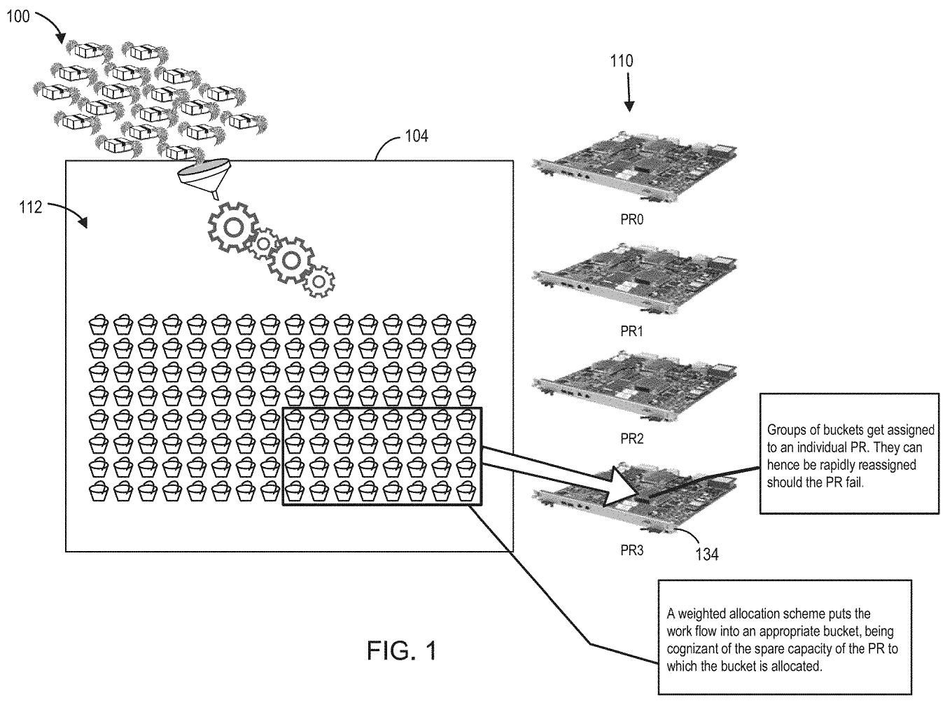

Because Radisys focuses on network solutions, it tends to see individual work packages in terms of a so-called flow. The disclosed embodiments, however, are equally applicable to individual batch jobs, transactions, or in fact any work package relating to a discrete unit of work which can be allocated to any element in a service pool of processing resources. In other words, although FIG. 1 shows incoming work packages 100, and the present disclosure discusses examples of distributing flows, skilled persons will appreciate that the disclosed techniques are also applicable to different types of units of work including transaction requests and identifying work packages on the basis of subscriber identity.

Subscriber means an individual or organization that receives an internet connection as a service for one or more end-user devices like mobile phones, laptops, or other devices using the internet or arranged to receive a service from a network device. Subscribers typically have unique packet forwarding tasks depending upon what they are doing, e.g., Facebook chat, Netflix movie steam, browsing, or other internet-centric activities. In some embodiments, there is at least one packet processing rule for each application that a subscriber is using, and such rules have a corresponding action describing what actions are to be taken for flow, e.g., electing to rate limit Netflix stream at peak time to ensure low latency on voice calls.

Transaction requests are a sequence of information exchange and related work (such as database updating) that is treated as a non-divisible (atomic) unit for the purposes of satisfying a request and for ensuring database integrity. For a transaction to be completed and state changes to be made permanent, a transaction has to be successfully executed in its entirety. The workflow associated with an online purchase may be seen as a single transaction.

Techniques described in this disclosure are applicable to distributing units of work across a pool of any generic processing resources such as: servers, virtual machines (VMs), processing cores, and other resources. For example, the disclosed techniques are applicable to distributing load-balanced traffic to pools of VMs providing a network service in the context of an individual service function (e.g., L4-L7 firewall, network address translation, or intrusion protection), which may be just one stage of service function chaining (SFC). Accordingly, the term processing resource (PR) is used throughout this disclosure to refer to any compute element capable of processing a discrete portion (i.e., unit of work or work package) of an overall workload.

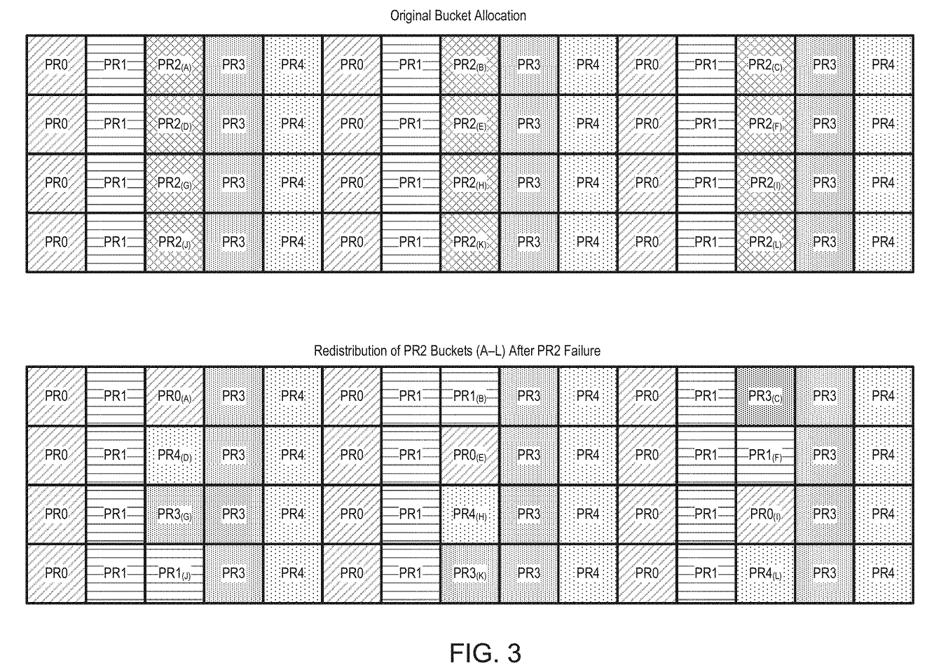

FIG. 1 shows a load balancer 104 that allocates to each of four available PRs 110 one or more buckets 112. The term bucket can have several meanings in computing. It is used both as a live metaphor and as a generally accepted technical term in some specialized areas. In general, a bucket is a type of data buffer or data structure that segregates data based on some criteria. For example, in a load-balancing context of FIG. 1, each bucket 112 represents a group of pointers mapping or logically associating a set of units of work processable by a PR to which the bucket is allocated. The set in a bucket may be of unlimited size, a single packet, or no packets (i.e., an empty bucket). One or more buckets are allocated to a PR acting as the target for each packet assigned to the one or more buckets. Specifically, a fourth PR (PR3) 134 is shown as being allocated an array of buckets, and each of the other PRs is represented by its own group of buckets. The particular allocation of buckets-to-PRs is also updatable, as described later with reference to FIG. 3. Reallocation of buckets provides for more uniform workload redistribution between surviving PRs when a PR fails.

According to one embodiment, the load balancer 104 (or other type of network device) is configured to parse packet header fields of the work packages 100 (e.g., network packets) to identify certain attributes and parameters that identify a work package as being a member of a set previously assigned to a bucket. For instance, a flow (formed by a stream of bi-directional packets traversing between a particular client and server) is identifiable through a five-tuple classification. A five-tuple is an industry standard set of header fields having five values representing both source and destination IP addresses, both L4 port numbers, and the protocol: typically TCP or User Datagram Protocol (UDP). Flows, however, may also be identified through other classification mechanisms, not restricted to the specifically mentioned five-tuple fields. According to one embodiment, header fields of incoming packets are hashed or masked to create an index into the array of buckets.

If the work package has not been previously assigned, then it is identified as a new unit of work that will be assigned, based on the disclosed load-balancing distribution techniques, to an available PR for handling the work package. A weighted allocation scheme described in this disclosure places the work flow into an appropriate bucket based on the spare capacity of the target PR to which the bucket is allocated.

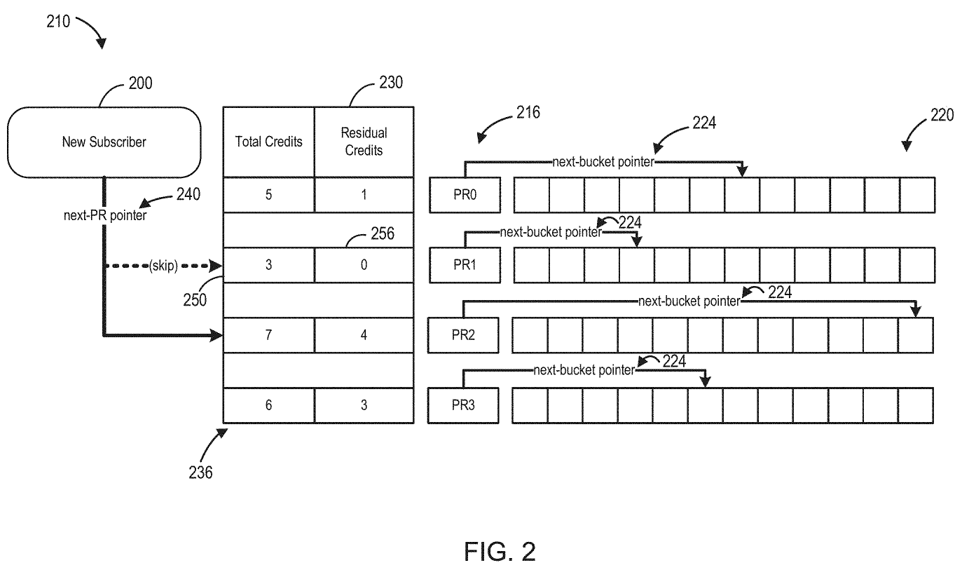

This concept of using buckets provides an indirect mechanism to group units of work and (re)distribute them between multiple PRs. Using buckets as discrete containers for bundles of work flows facilitates a potentially faster reallocation (see, e.g., FIG. 3) of units of work when a recovery action is needed to cope with the detected failure or gradual wind down of a PR. Buckets, however, are not necessarily required to provide weighted load balancing distribution as described in connection with FIG. 2 or redistribution as described in connection with FIG. 3.

In FIG. 2, a new subscriber 200 or flow (e.g., identified based upon its five-tuple) is to be assigned to a bucket. FIG. 2, therefore, represents an example method 210 for implementing a low latency load balancer algorithm cognizant of individual PR capacity. Of course, the implementation depicted is illustrative and other solutions are possible. Adherence to the particular method 210 is not mandatory for carrying out the general concept described herein; other methods, arrangements of actions, and quantity of PRs are also contemplated.

As in FIG. 1, there are four PRs 216, each of which is allocated an indexed array (or other group or list) of one or more buckets 220. Although shown arranged in a line, skilled persons will appreciate that each group of buckets 220 may be a circular array in that, once a next-bucket identifier 224 (e.g., index or pointer) reaches a final bucket, the next-bucket identifier 224 is advanced to an initial bucket of the group so as to establish the circular array.

An allocation table 230 (depicted as a two-column rectangle) maintains a weighted round-robin list 236 that is established based on recurring reports received from each PR of the multiple PRs 216. The recurring reports provide recent measures of spare processing capacity. For example, each PR may include a software thread that executes to assess its spare processing capacity. For example, a CPU can use operating system (OS) services to report an amount of free memory and to determine the current extent of spare CPU cycles. In the Linux environment, such spare capacity can be determined by a process which scans relevant files in the /proc directory.

In some embodiments, the load balancer 104 (FIG. 1) queries each PR to obtain such measures of spare processing capacity communicated through an application programming interface (API). In other embodiments, reports are not requested by a load balancer but are simply provided by a PR. In other words, the reports may be entirely or partly asynchronous, solicited (polled), or unsolicited (dynamic).

The weighted round-robin list 236 includes values of total and residual credits for each PR. For example, a left-side column maintains the values of total credits representing for a corresponding PR its proportional ability to accommodate units of work. Similarly, a right-side column maintains the values of the residual credits tracking for the corresponding PR whether it may be assigned in round-robin fashion an additional unit of work.

According to one embodiment, the multiple PRs may be assumed to have identical processing capabilities. In that case, total credits begin with an arbitrary value of 10 total credits for each PR. But then on the next update of total credits, after some initial assignments of units of work, some PRs will have fewer than 10 total credits since the individual workloads vary among the PRs and the workloads reduce spare processing capacity. In other embodiments, PRs have different capabilities and so relative weights of each PR may be based on millions of instructions per second (MIPS), available memory, a unit of flows per second (e.g., one million flows per second is represented as a value of 10 total credits), or similar performance measures. Thus, a PR having more available MIPS would have correspondingly more total credits. The actual values and units shown in FIG. 2, however, are simply representative examples of processing capacity and performance measures.

Each PR may derive the value of its total credits itself and report that value directly to the load balancer. In another embodiment, the load balancer derives the values for comparison purposes. For example, in some embodiments, the values of total credits are developed on each PR. In that case, each PR directly reports a number of directly comparable units stored in the allocation table, which may be updated in response to each report from a PR, updated periodically, or updated asynchronously once each PR has provided a report. In other embodiments, each PR may report a raw number of spare processing capacity, and the load balancer normalizes these raw numbers for comparing them. This embodiment is useful when different PRs report on different types of measures of spare processing capacity.

To identify, based on the weighted round-robin list 236, an available PR to handle a new unit of work, a next-PR identifier 240 advances through the allocation table 230 for each new flow ready to be assigned to the next available PR having residual credits. In other words, the available PR is indicated by the weighted round-robin list 236 as having a sufficient (e.g., a non-zero) amount of residual credits. Sufficient residual credits simply means the residual credits indicate available headroom to handle additional processing load. Different systems may actually decrement or increment credits to represent capacity to process new units of work. In other embodiments, a boolean flag or token is set to indicate whether the PR is accepting new units of work.

In the example of FIG. 2, the next-PR identifier 240 points to PR2 to which the new unit of work should be assigned. Thus, a row 250 for PR1 has been passed over because its residual credits 256 have already been exhausted. The new subscriber 200 will therefore be assigned to PR2. Once the next-PR identifier 240 reaches the end of the list 236, it loops back to the beginning. The ability to skip a PR is useful when the load balancer wants to avoid assignment of further units of work to a particular PR. For example, a total credits value of zero would indicate that the PR is fully loaded (has insufficient spare processing capacity) and is not seeking to receive further new flows (work packages), although it would continue to service flows already assigned to it. In another example, a value of zero could be used by a PR that has been instructed to gracefully spin down once all the current session flows it is handling expire. In the interim, the value of zero would inhibit the PR from being sent any new flows. This ensures that the PRs having a total credits value of zero will be freed up when the workload requirements of the overall system reduce, thereby facilitating true elastic scalability in a VM cloud or server farm. Accordingly, when a PR is to be taken out of service, the load balancer may simply modify the weighted round-robin list 236 to indicate that the particular PR has no spare processing capacity irrespective of its reported processing capacity. In one embodiment, the load balancer changes the value of total or residual credits of the particular PR (e.g., sets it to zero) so as to suppress new-work assignment to the particular PR. In another embodiment, a flag or token is set to indicate the PR should not be assigned new units of work. In yet another embodiment, PRs are instructed to report they seek no new units of work (e.g., report zero total credits).

The new unit of work is assigned to a pre-allocated bucket of PR2 that is pointed at by its next-bucket identifier 224. The next-bucket identifier 224 associated with PR2 will indicate which bucket this flow should be assigned to. The next-bucket identifier 224 would then be advanced to point at the next bucket in this PR's group. In this example, a pointer will on this occasion wrap around to the start of the array because it has reached the end.

After the flow is assigned, the value of the residual credits 256 for PR2 is changed (e.g., decremented). Also, the next-PR identifier 240 is advanced to point at the next PR with sufficient (e.g., non-zero residual) credits so as to thereby proportionally distribute the units of work to PRs based on their reported spare processing capacity.

When the residual credits of the allocation table 230 are exhausted, e.g., the values of the residual credits for all PRs reach zero, the allocation table 230 is refreshed and values of the residual credits are set back to the number of total credits assigned by the weighting algorithm.

Total credits are periodically reloaded asynchronously by a PR load capacity monitoring thread, according to one embodiment. The load balancer may simultaneously update all of the values of total credits or it may update the values individually in response to a report from a PR. In another embodiment, the total credits are updated in response to all of the residual credits being exhausted.

FIG. 3 shows that buckets can be redistributed between surviving members of a PR pool should a PR fail. Thus, should a PR fail, its buckets are redistributed by sequentially appending them to the end of the list of buckets for each of the remaining active PRs, according to one embodiment. This can be done without consideration of the relative loading of each PR by sequentially allocating in round-robin fashion buckets of the failed PR to the remaining active PRs of the multiple PRs irrespective of the relative loading of each active PR. The advantage of this is one of simplicity with an expectation that uneven loading would be ironed out over time.

In contrast, another embodiment takes into account the total or residual credits when reassigning buckets to surviving PRs. For example, in order to take account of relative PR loading when reassigning buckets to the surviving PRs, the algorithm also applies such weighting when redistributing buckets as part of the recovery actions in response to a PR failing. Here, redistributing comprises reassigning one or more buckets of the failed PR to surviving PRs based on their relative loading.

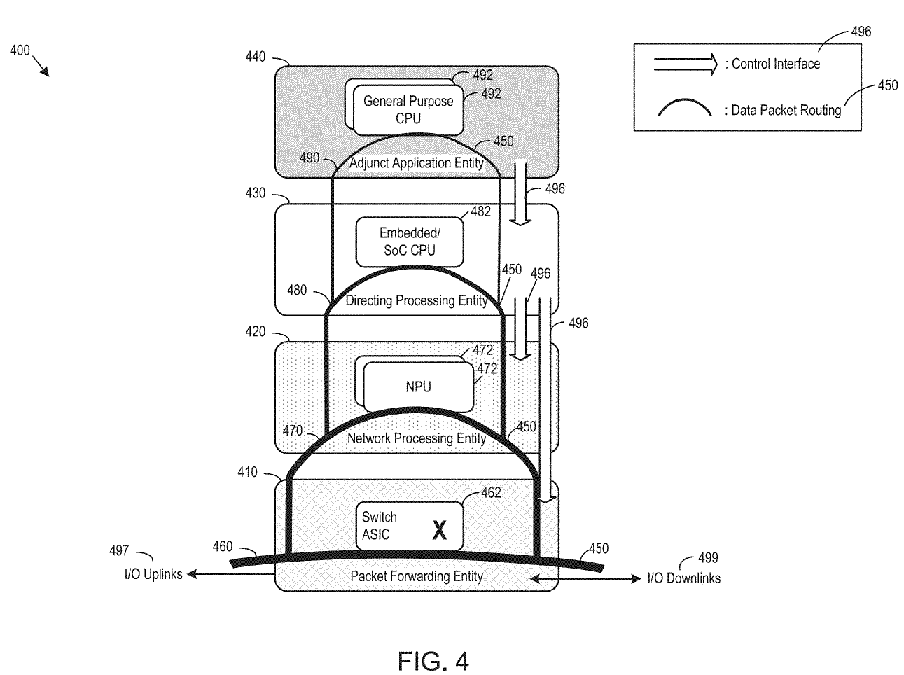

FIG. 4 shows a flow-processing hierarchical system 400 including four hierarchical levels (also called tiers). Initially, this tiered paradigm is briefly described so as to explain how the components are employed to achieve the weighted load balancing techniques that are the subject of this disclosure. Additional details of the tiered paradigm, however, are set forth in U.S. patent application Ser. No. 15/435,131, titled “System of Hierarchical Flow-Processing Tiers,” which is hereby incorporated by reference herein in its entirety.

Each hierarchical level of processing handles increasingly higher levels of computational complexity and flexibility at a gradual corresponding reduction in flow-processing throughput. In the system 400, four levels correspond to four different entities: a packet forwarding entity 410, a network processing entity 420, a directing processing entity 430, and an adjunct application entity 440. In some embodiments, these are separate physical entities in the sense that each entity and its associated flow-processing task(s) are implemented by a separate hardware device, e.g., a processor—such as a microprocessor, microcontroller, logic circuitry, or the like—and associated electrical circuitry, which may include a computer-readable storage device such as non-volatile memory, static random access memory (RAM), dynamic RAM (DRAM), read-only memory (ROM), flash memory, or other computer-readable storage medium. In other embodiments, however, multiple entities may be implemented in common hardware such that software establishes a logical separation between the multiple entities. Accordingly, entities need not be separate physical entities in some embodiments.

Data packet routes 450 through the flow-processing hierarchical system 400 are represented as solid, arcuate lines having line weights proportional to relative amounts of available throughput. The data packet routes 450 are as follows: first is a data packet route 460 through a switch application-specific integrated circuit (ASIC) 462; second is a data packet route 470 through one or more NPUs 472; third is a data packet route 480 through a local management processor (LMP) 482, e.g., a system on chip (SoC) central processing unit (CPU); and fourth is a data packet route 490 to or through adjunct servers implemented by general purpose CPUs 492. Also, control interface paths 496 are represented by unfilled arrows indicating instantiation, in the lower levels, of rules employed in fast, scalable tables.

The packet forwarding entity 410 is the first (base) level that includes the switch ASIC 462, input-output (I/O) uplinks 197, and I/O downlinks 499. The packet forwarding entity 410 is characterized by layer two (data link layer, L2) or layer three (network layer, L3) (generally, L2/L3) stateless forwarding, relatively large I/O fan-out, autonomous L2/L3 processing, highest performance switching or routing functions at line rates, and generally less software-implemented flexibility. Data packets designated for local processing are provided to the network processing entity 420. Accordingly, the base level facilitates, in an example embodiment, at least about one Tb/s I/O performance while checking data packets against configurable rules to identify which packets go to the network processing entity 420. For example, the first level may provide some data packets to the network processing entity 420 in response to the data packets possessing certain destination IP or media access control (MAC) information, virtual local area network (VLAN) information at the data link layer, or other lower-level criteria set forth in a packet forwarding rule.

The network processing entity 420 is the second highest level that includes the NPUs 472 such as an NP-5 or NPS-400 available from Mellanox Technologies of Sunnyvale, Calif. A network processor is an integrated circuit which has a feature set specifically targeted at the networking application domain. Network processors are typically software programmable devices and would have generic characteristics similar to general purpose CPUs that are commonly used in many different types of equipment and products.

The network processing entity 420 is characterized by L2-L7 processing and stateful forwarding tasks including stateful load balancing, flow tracking and forwarding (i.e., distributing) hundreds of millions of individual flows, application layer (L7) deep packet inspection (DPI), in-line classification, packet modification, and specialty acceleration such as, e.g., cryptography, or other task-specific acceleration. The network processing entity 420 also raises exceptions for flows that do not match existing network processing rules by passing these flows to the directing processing entity 430. Accordingly, the second level facilitates hundreds of Gb/s throughput while checking data packets against configurable network processing rules to identify which packets go to the directing processing entity 430. For example, the second level may provide some data packets to the directing processing entity 430 in response to checking the data packets against explicit rules to identify exception packets and performing a default action if there is no existing rule present to handle the data packet.

The directing processing entity 430 is the third highest level that includes the embedded SoC 482, such as a PowerPC SoC, or a CPU such as an IA Xeon CPU available from Intel Corporation of Santa Clara, Calif. The directing processing entity 430 is characterized by coordination and complex processing tasks including control and data processing tasks. With respect to control processing tasks, which are based on directing processing rules (i.e., a policy) provided by the adjunct application entity 440, the directing processing entity 430 provisions through the control interface(s) 496 explicit (static) rules in the network processing entity 420 and the packet forwarding entity 410. Also, based on processing of exception packets, the directing processing entity 430 sets up dynamic rules in the network processing entity 420. With respect to data processing tasks, the directing processing entity 430 handles exception or head-of-flow classification of layer four (transport layer, L4) and higher layers (L4+), or other complex packet processing based on directing processing rules. Accordingly, the third level facilitates tens of Gb/s throughput while handling control processing, exception or head-of-flow classification, static rule (i.e., table) mapping, and rule instantiation into lower datapath processing tiers.

The adjunct application entity 440 is the fourth highest (i.e., apex) level that includes the general purpose CPUs 492 configured to provide the maximum flexibility but the lowest performance relative to the other tiers. The adjunct application entity 440 is characterized by specialty (i.e., application specific) processing tasks including policy, orchestration, or application node processing tasks. More generally, the adjunct application entity 440 provides access to this type of compute function closely coupled to the datapath via the described processing tier structures. With respect to control processing, the adjunct application entity 440 provides subscriber-, network-, or application-related policy information (i.e., rules) to the directing processing entity 430. And with respect to data processing tasks, the adjunct application entity 440 handles selected (filtered) packet processing based on adjunct application rules. Accordingly, the fourth level facilitates ones to tens of Gb/s throughput while handling—for a subset of identified flows for particular applications—data packet capture, DPI, and analytics (flexible, not fixed function), in which the data packets may flow through or terminate.

FIG. 4 also shows how the foregoing tiered approach to flow processing is employed for realizing a weighted load balancing function managed by the directing processing entity 430. Individual flows (i.e., units of work) are directed to, for execution on, downstream PRs (not shown), which include CPUs, containers, or VMs deployed within a cloud infrastructure. Applications running on these PRs may have their own means of assessing spare capacity, as discussed previously. According to one embodiment, the PRs extrapolate their spare capacity and report it to the directing processing entity 430 (or other coordinating agent) as a value ranging from 0 to 10.

The directing processing entity 430 collects capacity advertisement messages (or similar reports) from each PR and compares them with the capacity updates which it recurrently receives from the other PRs. Any method of obtaining such capacity updates is contemplated, including asynchronously receiving unsolicited updates or deliberately polling PRs for updates.

Having compared the advertised spare capacities from the pool of PRs, the directing processing entity 430 is in a position to assign the appropriate weighting to be applied by the load balancer when allocating new workloads across the PR pool.

When a new flow (or work package arrives) the load balancer will assign it to a suitable PR that is selected by taking account of the weightings passed down to it from the directing processing entity 430. When assigning a new flow to a PR, the load balancer makes the allocation to a particular bucket corresponding to the PR. Such high throughput, low latency load balancing decisions are made by the packet forwarding entity 410 based on a weighted round-robin list provided by the directing processing entity 430.

One implementation (but others are possible) is for the directing processing entity 430 to maintain a table (or other data structure) representing a weighted round-robin list stored within the NPU 472 of the network processing entity 420, in which the table is derived from the current reported loading of the PRs. When a new flow needs to be allocated, the PR is selected based upon a token or credit scheme maintained in the table as explained previously (see, e.g., FIG. 2). The values of the residual credits are reloaded to equal those of the total credits assigned to each PR by the directing processing entity 430, according to one embodiment.

In some embodiments, the load balancer 104 or the system 400 include a microprocessor, microcontroller, field programmable gate array (FPGA), other logic device, or the like, including associated electrical circuitry that performs logic operations to carry out aspects of the described methods and processes. The term circuitry may refer to, be part of, or include an ASIC, an electronic circuit, a processor (shared, dedicated, or group), or memory (shared, dedicated, or group) that executes one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

According to some embodiments, the load balancer 104 or the system 400 includes machine-readable storage storing instructions that, when executed, cause the processor to perform the methods and processes described in connection with FIGS. 1-3. The machine-readable storage may comprise a computer-readable storage medium such as non-volatile memory, RAM, DRAM, ROM, flash memory, or other computer-readable storage medium. Thus, the aforementioned techniques may also be implemented in software, firmware, or other programmable rules or hardcoded logic operations that may include or be realized by any type of computer instruction or computer-executable code located within, on, or embodied by a non-transitory computer-readable storage medium that may contain instructions that, when executed by a processor or logic circuitry, configure the processor or logic circuitry to perform any method described in this disclosure.

Moreover, instructions may, for instance, comprise one or more physical or logical blocks of computer instructions, which may be organized as a routine, program, object, component, data structure, text file, or other instruction set, which facilitates one or more tasks or implements particular data structures. In certain embodiments, a particular programmable rule or hardcoded logic operation may comprise distributed instructions stored in different locations of a computer-readable storage medium, which together implement the described functionality. Indeed, a programmable rule or hardcoded logic operation may comprise a single instruction or many instructions, and may be distributed over several different code segments, among different programs, and across several computer-readable storage media. Some embodiments may be practiced in a distributed computing environment where tasks are performed by a remote processing device linked through a communications network.

Skilled persons will understand that many changes may be made to the details of the above-described embodiments without departing from the underlying principles of the invention. The scope of the present invention should, therefore, be determined only by the following claims.

1. A load-balancing method for proportionally distributing units of work to multiple processing resources (PRs) based on spare processing capacity reported by each PR, the units of work comprising network packet flows, subscribers, or transaction requests, the method comprising:
allocating to each PR one or more buckets, each bucket representing a group of pointers that map a set of units of work processable by a PR to which the bucket is allocated;
establishing a weighted round-robin list based on recurring reports received from each PR of the multiple PRs, the recurring reports providing recent measures of spare processing capacity, the weighted round-robin list including values of total and residual credits for each PR, the total credits representing for a corresponding PR its proportional ability to accommodate units of work, and the residual credits tracking for the corresponding PR whether it may be assigned in round-robin fashion an additional unit of work;
identifying, based on the weighted round-robin list, an available PR to handle a new unit of work, the available PR being indicated by the weighted round-robin list as having a sufficient amount of residual credits; and
assigning the new unit of work to a pre-allocated bucket allocated to the available PR and changing its value of residual credits so as to thereby proportionally distribute the units of work to PRs based on their reported spare processing capacity.

2. The method of claim 1, in which the units of work comprise network packet flows.

3. The method of claim 1, further comprising soliciting the recurring reports from the PRs.

4. The method of claim 1, in which the obtaining comprises executing an asynchronous thread to receive from the multiple PRs periodic updates of spare processing capacity.

5. The method of claim 4, further comprising updating the values of the total credits of the weighted round-robin list in response to the periodic updates so as to proportionally represent the spare processing capacity as most recently reported by the multiple PRs.

6. The method of claim 5, further comprising, in response to a report from a PR, individually updating its value of total credits.

7. The method of claim 1, further comprising in response to it indicating that no PR of the multiple PRs possesses residual credits, updating the weighted round-robin list by resetting the values of the residual credits to equal those of corresponding total credits.

8. The method of claim 1, further comprising, in response to a failure of a failed PR, redistributing its one or more buckets among other PRs of the multiple PRs.

9. The method of claim 8, in which the redistributing comprises sequentially allocating in round-robin fashion buckets of the failed PR to remaining active PRs of the multiple PRs irrespective of relative loading of each active PR.

10. The method of claim 8, in which the redistributing comprises reassigning one or more buckets of the failed PR to surviving PRs based on their relative loading.

11. The method of claim 1, further comprising storing, for each PR, a next-bucket identifier to indicate from a set of buckets allocated to an associated PR which member of the set the new unit of work is to be assigned.

12. The method of claim 1, further comprising:
advancing a next-PR identifier through the weighted round-robin list for each new unit of work; and
skipping any PR indicated by the weighted round-robin list as having insufficient spare processing capacity.

13. The method of claim 12, further comprising looping back to a start of the weighted round-robin list in response to the next-PR identifier reaching a final PR listed in the weighted round-robin list.

14. The method of claim 1, further comprising avoiding assignment of further units of work to a particular PR by modifying the weighted round-robin list to indicate that the particular PR has no spare processing capacity irrespective of its reported processing capacity.

15. The method of claim 14, further comprising setting to zero the value of total or residual credits of the particular PR so as to suppress new-work assignment to the particular PR.

16. A load balancer including machine-readable storage have stored thereon instructions that, when executed, cause the load balancer to implement the method of claim 1.

17. A load balancer for proportionally distributing units of work to multiple processing resources (PRs) based on spare processing capacity reported by each PR, the units of work comprising network packet flows, subscribers, or transaction requests, comprising circuitry configured to:
allocate to each PR one or more buckets, each bucket representing a group of pointers that map a set of units of work processable by a PR to which the bucket is allocated;
establish a weighted round-robin list based on recurring reports received from each PR of the multiple PRs, the recurring reports providing recent measures of spare processing capacity, the weighted round-robin list including values of total and residual credits for each PR, the total credits representing for a corresponding PR its proportional ability to accommodate units of work, and the residual credits tracking for the corresponding PR whether it may be assigned in round-robin fashion an additional unit of work;
identify, based on the weighted round-robin list, an available PR to handle a new unit of work, the available PR being indicated by the weighted round-robin list as having a sufficient amount of residual credits; and
assign the new unit of work to a pre-allocated bucket allocated to the available PR and changing its value of residual credits so as to thereby proportionally distribute the units of work to PRs based on their reported spare processing capacity.

18. The load balancer of claim 17, in which the circuitry is further configured to, in response to a failure of a failed PR, redistribute its one or more buckets among other PRs of the multiple PRs.

19. The load balancer of claim 18, in which the redistributing comprises sequentially allocating in round-robin fashion buckets of the failed PR to remaining active PRs of the multiple PRs irrespective of relative loading of each active PR.

20. The load balancer of claim 17, in which the circuitry is further configured to avoid assignment of further units of work to a particular PR by modifying the weighted round-robin list to indicate that the particular PR has no spare processing capacity irrespective of its reported processing capacity.
